(19) United States
(12) Patent Application Publication
(10) Pub. No.: US 2024/0016207 A1
(43) Pub. Date: Jan. 18, 2024

(54) CAP FOR SIMULATED SMOKING SYSTEMS

(71) Applicant: Nicoventures Trading Limited, LONDON (GB)

(72) Inventors: Ayah ABDULLAH, West Montreal (CA); Bonifacio SPINOLA, Rome (IT)

(21) Appl. No.: 18/252,732

(22) PCT Filed: Sep. 29, 2021
(86) PCT No.: PCT/GB2021/052521

§ 371 Date: May 12, 2023

(30) Foreign Application Priority Data
Nov. 13, 2020 (GB) 2017939.6

(51) Int. Cl. A24F 40/40; A24F 7/00; F16J 15/02

(52) U.S. Cl. CPC A24F 40/40; A24F 7/00; F16J 15/02

(57) ABSTRACT

A cap for use with a delivery system, the cap including an outer wall defining an internal cavity configured to receive a mouthpiece of the delivery system, and a sealing element within the cavity configured to engage with the delivery system mouthpiece and to seal an outlet of the delivery system mouthpiece, when the cap is fitted to a delivery system.

### PRIORITY CLAIM

The present application is a National Phase entry of PCT Application No. PCT/GB2021/052521, filed Sep. 29, 2021, which claims priority from GB Application No. 2017939.6, filed Nov. 13, 2020, each of which is hereby fully incorporated herein by reference.

### TECHNICAL FIELD

The present invention relates to a cap for use with a delivery system and a delivery system comprising a cap.

### BACKGROUND

Some delivery systems are provided with a cap to cover and/or protect a part of the delivery system. The cap is typically removable and in some cases can be reusable. Some delivery systems comprise a mouthpiece for the delivery of a substance to a user's mouth. A cap can be provided to cover the mouthpiece until such a time that the user requires access to the mouthpiece, at which point, the cap is typically removed by the user.

### SUMMARY

In accordance with some embodiments described herein, there is provided a cap for use with a delivery system, the cap comprising an outer wall defining an internal cavity configured to receive a mouthpiece of the delivery system, and a sealing element within the cavity configured to engage with the delivery system mouthpiece and to seal an outlet of the delivery system mouthpiece, when the cap is fitted to a delivery system.

The sealing element may comprise a formation extending into the internal cavity configured to be received within an outlet of a delivery system mouthpiece so as to seal the outlet when the cap is fitted to a delivery system.

The sealing element may comprise a formation extending into the internal cavity which may surround, or may extend across an outlet of a delivery system mouthpiece so as to seal the outlet when the cap is fitted to a delivery system.

The sealing element may be integrally formed with the outer wall.

The sealing element may be a separate component to the outer wall which may be secured thereto.

The sealing element may be at least partially formed from the same material as the outer wall.

The sealing element may comprise a portion of resilient material which may be configured to be compressed against at least a part of a delivery system mouthpiece when the cap is fitted to a delivery system.

The sealing element may be entirely formed from the same material as the outer wall.

The sealing element may be a rigid formation.

The sealing element may be entirely comprised of a resilient or compressible material.

The sealing element may comprise a first end which may extend towards the entrance opening of the cap and a second end which may be coupled to the outer wall.

The cap may comprises a first end proximate the entrance opening and a second end opposite to the first end.

The sealing element may extend over less than 25% of a distance from the second end to the first end of the cap.

The outer wall may comprise an end wall at the second end and a sidewall extending from the end wall to the entrance opening, wherein the end wall may comprise the sealing element.

The sealing element may comprise a sealing wall surrounding a sealing cavity, the sealing wall may be configured to engage a mouthpiece of the delivery system so as to seal an outlet of the mouthpiece when the cap is fitted to a delivery system, wherein the sealing cavity may remain in fluid communication with the outlet.

The sealing element may comprise a well to receive a tip of a mouthpiece of a delivery system when the cap is fitted to a delivery system, wherein the well may be formed as a pocket in the first end of the sealing element.

The well may comprise a base and a distance between the base and the second end of the sealing element may be less than a distance between the first end of the sealing element and the second end of the sealing element.

The sealing element may comprise a sealing layer which may extend substantially flat across the internal cavity before the cap is fitted with a delivery system, the sealing layer may comprise a compressible material to which a mouthpiece of a delivery system may be pushed into so as to seal an outlet of the mouthpiece when the cap is fitted with a delivery system.

The sealing element may comprise a sealing ring, which may extend annularly around the internal cavity so as to form a seal with a mouthpiece of a delivery system when the cap is fitted with a delivery system.

The cap may comprise a central longitudinal plane extending through the first end, the internal cavity and the second end and the sealing element may be arranged symmetrically about the central longitudinal plane.

The cap may comprise at least one aperture through the outer wall.

An airflow passage may be defined through the internal cavity between the aperture(s) and the entrance opening.

The cap may further comprise at least one inner wall which may be configured so as to be disposed between the outer wall and a mouthpiece of the delivery system when the cap is fitted to a delivery system, wherein an airflow passage may be defined at least by the outer wall and the or at least one of the inner wall(s).

The cap may further comprise a receiving portion which may be configured to engage with a delivery system to secure the cap to the delivery system.

The receiving portion may comprise at least one formation extending into the internal cavity, which may be configured to provide a friction fit attachment with a delivery system.

The formation may be substantially elongate, and may extend from a first end of the cap towards a second end of the cap, wherein the second end may be where the inhalation device is received.

The cap may comprise four formations, which may be arranged around the internal surface of the receiving portion.

The formations may comprise a resilient material. The formations may be rigid and/or may be formed of the material of the outer wall.

The formations may be provided towards each corner of a body of the inhalation device.

In accordance with some embodiments described herein, there is provided a delivery system comprising a mouthpiece and a body, and cap removably attached to the delivery system to cover the mouthpiece, wherein the mouthpiece comprises an outlet for delivery of a substance to user.

The sealing element may seal an outlet of the delivery system mouthpiece.

The sealing element may be received within the outlet.

The sealing element may surround, or may extend across the outlet.

The airflow passage may be defined between the outer wall and the mouthpiece.

The at least one inner wall may be disposed between the outer wall and a mouthpiece of the delivery system and the airflow passage may be defined at least by the outer wall and the or at least one of the inner wall(s).

The airflow passage may be fluidly isolated from the outlet of the mouthpiece.

The cap may be removably attachable to both a first end of the electronic inhalation device and a second end of the electronic inhalation device, wherein the first end may comprise the mouthpiece.

The cap may further comprise a secondary sealing element within the cavity which may be configured to engage with a portion of the delivery system to substantially seal the internal cavity.

The end wall may be substantially elliptical in shape. The end wall may be substantially polygonal in shape.

The outer wall may comprise a substantially consistent thickness.

The outer wall may be rigid.

The outer wall may be shaped to closely fit the mouthpiece of a delivery system, such that when the mouthpiece is received in the cap, the internal cavity may be substantially filled by the mouthpiece.

The receiving portion may comprise a cross sectional area that is greater than a cross sectional area of the lid.

The sealing element may be made of a resilient material. The material may be for example but not limited to rubber, foam, an elastomer or silicone.

### BRIEF DESCRIPTION OF THE DRAWINGS

Embodiments of the invention will now be described, by way of example only, with reference to the accompanying drawings, in which:

FIG. 1 shows a cap of an embodiment assembled on a first end of a delivery system comprising a mouthpiece;

FIG. 2 shows the cap of FIGS. 1 to 5 assembled on a second end of a delivery system comprising a mouthpiece;

FIG. 3 shows a perspective front view of the cap for a delivery system of FIGS. 1 to 5 comprising a sealing element;

FIG. 4 shows a top view of the cap for a delivery system of FIGS. 1 to 5;

FIG. 5 shows a schematic cross-sectional front view of the cap of FIGS. 1 to 5 showing the sealing element extending into the outlet and a conduit of the mouthpiece of the delivery system;

FIG. 6 shows a schematic cross-sectional front view of a cap for a delivery system according to another embodiment comprising a sealing element comprising a sealing wall defining a sealing cavity;

FIG. 7 shows a schematic top view of the cap of FIG. 6;

FIG. 8 shows a schematic cross-sectional front view of a cap for a delivery system according to another embodiment comprising a sealing element comprising a well for receiving a tip of the mouthpiece of the delivery system;

FIG. 9 shows a schematic top view of the cap of FIGS. 8 to 10;

FIG. 10 shows a schematic cross-sectional front view of a cap of FIGS. 8 to 10 when the mouthpiece is not received in the cap;

FIG. 11 shows a schematic cross-sectional front view of a cap for a delivery system according to another embodiment comprising a sealing element comprised of a second material;

FIG. 12 shows a schematic cross-sectional front view of a cap of FIGS. 11 to 13 when the mouthpiece is not received in the cap;

FIG. 13 shows a schematic top view of the cap of FIGS. 11 to 13;

FIG. 14 shows a schematic cross-sectional front view of a cap for a delivery system according to another embodiment comprising a sealing layer comprised of a compressible material;

FIG. 15 shows a schematic top view of the cap of FIG. 14;

FIG. 16 shows a schematic cross-sectional front view of a cap for a delivery system according to another embodiment comprising a sealing ring and an inner wall;

FIG. 17 shows a schematic top view of the cap of FIG. 16;

FIG. 18 shows a schematic cross-sectional front view of a cap for a delivery system according to another embodiment comprising at least one aperture and an additional sealing portion;

FIG. 19 shows a schematic top view of the cap of FIG. 18.

### DETAILED DESCRIPTION

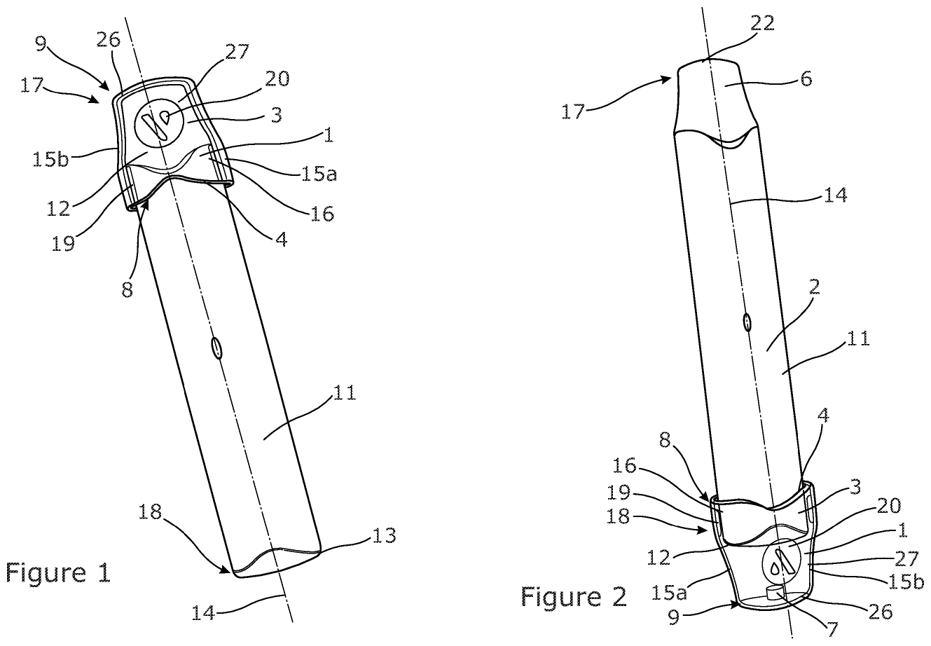

Referring now to FIGS. 1 to 5, an embodiment of a cap 1 for a delivery system 2 is shown.

In the present embodiment, the delivery system 2 is a non-combustible aerosol provision system 2. However, in alternative embodiments (not shown), the delivery system 2 described herein can be implemented as an arrangement other than a non-combustible aerosol provision system 2. For example, the delivery system 2 may be a combustible aerosol provision system (not shown) or an aerosol-free delivery system (not shown).

FIG. 1 shows a cap 1 assembled with a delivery system 2. The delivery system 2 comprises a mouthpiece 6 at a first end 17 and a base 13 at a second end 18. The delivery system 2 further comprises a body ii extending between the first end 17 and the second end 18. The mouthpiece 6 comprises an aperture or outlet 22, through which delivery of a substance to a user's mouth occurs, when a user draws on the mouthpiece 6. The cap 1 is assembled with the first end 17 of the delivery system.

FIG. 2 shows the cap 1 assembled with the second end 18 of the delivery system 2. In some embodiments the cap 1 is configured to be removably attachable to both the first end 17 and the second end 18 of the delivery system 2.

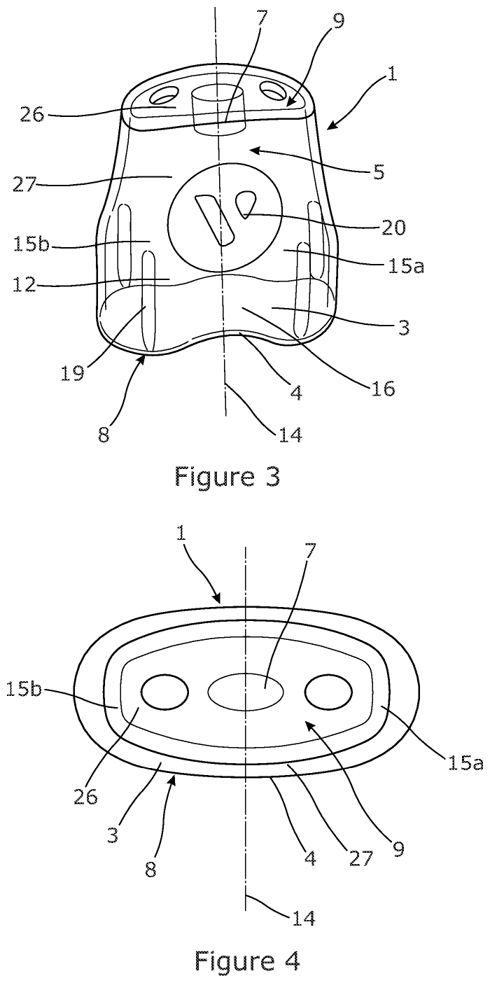

FIG. 3 shows the cap 1 comprising an outer wall 3 defining an entrance opening 4 and an internal cavity 5. The cap 1 is configured to receive the mouthpiece 6 of the delivery system 2 within the internal cavity 5.

In some embodiments the outer wall 3 is shaped to closely fit the mouthpiece 6 of the delivery system 2, such that when the mouthpiece 6 is received in the cap 1, the internal cavity 5 is substantially filled by the mouthpiece 6.

The cap 1 comprises a first end 8 proximate the entrance opening 4 and a second end 9 at the opposite end of the cap 1 from the first end 8.

The cap 1 comprises a central plane 14 extending through the first end 8, the internal cavity 5 and the second end 9. The cap 1 comprises two substantially equal portions 15a, 15b, one each side of the central plane 14. The cap 1 has a length along the central longitudinal plane 14 which is greater than the width of the cap 1 measured perpendicular to the central plane 14.

The outer wall 3 is made of a rigid material such as a rigid plastic. The outer wall 3 being made of a rigid material advantageously reduces the risk of the outer wall 3 collapsing when a user grips the cap 1 to remove it from the delivery system 2. If the cap 1 collapses as a user grips it, the user may also be gripping the mouthpiece 6 which in turn may hinder removal of the cap 1 from the delivery system 2.

The internal cavity 5 comprises a greater cross sectional area towards the entrance opening 4 than towards the second end 9. As shown best in FIGS. 1 and 2, this greater cross sectional area is configured to receive a portion of the delivery system 2. The portion of the delivery system 2 may be for example, but not limited to, the mouthpiece 6, the body ii of the delivery system 2, or the base 13 of the delivery system 2.

The internal cavity 5 comprising a greater cross-sectional area towards the entrance opening 4 can advantageously provide a stop where the internal cavity 5 narrows, to prevent the cap 1 from being pushed too far onto the delivery system 2. The point at which the internal cavity 5 narrows can be referred to as a shoulder 12. The portion of the delivery system 2 received in the internal cavity 5 abuts the shoulder 12 and cannot be pushed in any further. This may prevent excessive pressure from being applied to the second end 9 of the cap 1 or to the portion of the delivery system 6, 13, received in the cap 1.

The portion of the outer wall 3 which surrounds the entrance opening 4 to receive a portion of the delivery system 2 is herein referred to as receiving portion 16.

The receiving portion 16 is configured to provide a close fit against the aforementioned portion of the delivery system 2 such that when the delivery system 2 is received in the cap 1, the cap 1 remains attached to the delivery system 2 until such time that the user removes the cap 1. The cap 1 is removed by a user pulling the cap 1 in an axial direction away from the delivery system 2, overcoming friction existing between the cap 1 and the delivery system 2.

In embodiments in which the cap 1 is attachable to the first end 17 and the second end 18 the receiving portion 16 is shaped such that it is suitable for engagement with both ends 17, 18.

The cap 1 further comprises a sealing element 7. The sealing element 7 is provided within the internal cavity 5. When the mouthpiece 6 is received in the cap 1, the sealing element 7 is configured to engage with the mouthpiece 6 of the delivery system 2, and to seal the outlet 22. When the mouthpiece 6 is received in the cap 1, the cap 1 is assembled with the first end 17 of the delivery system 2.

Advantageously, sealing the outlet 22 of the mouthpiece 6 reduces the risk of debris or contaminants from entering the outlet 22, and therefore entering the delivery system 2. Sealing the outlet 22 also facilitates the prevention of any of the substance provided in the delivery system 2 from being drawn from the delivery system 2 until such a time that the cap 1 is removed, or from any leakage of the substance through the outlet 22 until the cap 1 is removed.

Isolating the outlet 22 from an external environment surrounding the delivery system 2 typically means that the substance contained in the delivery system 2 is at less risk of being contaminated by external environmental conditions. For example the substance may be affected by hot or wet weather, which can facilitate evaporation, cause a change in properties or provide added moisture content to the substance.

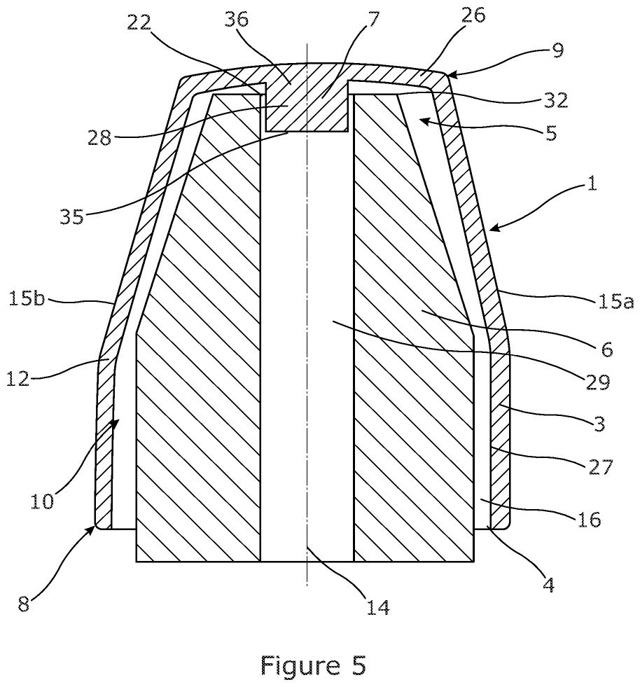

As shown best in FIG. 5 the sealing element 7 comprises a formation 28 extending into the internal cavity 5. This formation 28 is configured to be received within the outlet 22 of the mouthpiece 6 when the cap 1 is assembled with the first end 17 of the delivery system 2 to seal the outlet 22.

The mouthpiece 6 comprises a conduit 29 extending from the outlet 22 and into the delivery system 2. In use, when a user draws on the mouthpiece 6 of the delivery system 2, a substance travels up the conduit 29, through the outlet 22 and into a user's mouth. The sealing element 7 extends through the outlet 22 and at least partially in to the conduit 29 to seal the outlet 22, when the cap 1 is assembled on the first end 17 of the delivery system 2.

In the embodiment shown in FIGS. 1 to 5, a length of the formation 28 extending in the direction of the first end 8 of the cap 1, is greater than a width measured perpendicularly to the direction of the first end 8.

Advantageously the sealing element 7 extending into the conduit 29 facilitates an improved engagement between the mouthpiece 6 and the sealing element 7. This is because when the cap 1 is assembled on the first end 17, the sealing element 7 cannot be easily knocked out of alignment with the outlet 22 as it is received within the outlet 22.

The sealing element 7 is made of the same material as the outer wall 3. In some embodiments such as that shown in FIGS. 1 to 5, the sealing element 7 is integrally formed with the outer wall 3. In other embodiments, the sealing element 7 may be a separate element secured to the cap 1, for example by bonding, co-molding, mechanical fastening or other means. The sealing element 7 is made of a rigid material.

The sealing element 7 is sized to fit precisely within the outlet 22 of the mouthpiece 6. The sealing element is small enough such that it is removable from the outlet 22 after engagement, and large enough such that it is configured to seal the outlet 22 when in engagement.

The sealing element 7 is shaped to fit precisely within the outlet 22 of the mouthpiece 6. As the outlet 22 of the mouthpiece 6 of the embodiment shown in FIGS. 1 to 5 comprises an elliptical cross-sectional area, the sealing element 7 also comprises an elliptical cross-sectional area.

The sealing element 7 comprises a first end 35 which extends towards the first end 8 of the cap 1 and a second end 36 which is coupled to the second end 9 of the cap 1. The sealing element 7 extends over less than 25% of the distance from the second end 9 to the first end 8 of the cap 1.

The sealing element 7 is disposed centrally at the second end 9 of the cap 1 such that an equal portion of the sealing element is disposed either side of the central plane 14. Advantageously the sealing element 7 being disposed centrally assists in locating the cap 1 centrally on the delivery system 2 when assembling the cap 1 with the first end 17 of the delivery system 2.

In some embodiments the outer wall 3 comprises an end wall 26 at the second end 9 and a side wall 27 extending from the end wall 26 to the entrance opening 4, wherein the end wall 26 comprises the sealing element 7. The end wall 26 comprises a smaller cross-sectional area than the entrance opening 4. The end wall 26 extends substantially perpendicular to the side wall 27. In some embodiments the end wall 26 is curved or rounded with respect to the central plane 14, alternatively the end wall 26 is substantially flat, i.e. perpendicular to the central plane 14.

In some embodiments the cap 1 further comprises at least one engagement member 19. The engagement member 19 is configured to fit against the aforementioned portion of the delivery system 2 such that a user must overcome friction existing between the engagement member 19 and the delivery system 2 to remove the cap 1.

The engagement member 19 is provided in the receiving portion 16. The engagement members 19 shown in FIGS. 1 to 5 are elongate formations extending into the internal cavity 5. The engagement member 19 extends from near the entrance opening 4 to near the shoulder 12.

The engagement members 19 are formed of the same material as the outer wall 3. The engagement members 19 shown in FIGS. 1 to 5 are integrally formed with the outer wall 3. The engagement members 19 are arranged symmetrically about the central plane 14. As seen best in FIG. 1 the cap 1 comprises four engagement members 19, two arranged on the first side 15a and two arranged on the second side 15b.

Advantageously providing the engagement members 19 symmetrically about the central plane 14 provides an equal engagement force on both sides 15a, 15b, of the cap 1. This facilitates the cap 1 being removed axially away from the delivery system 2 reducing the risk of the cap 1 being stuck on one side of the delivery system 2 and having to urge the cap 1 from one side to another 15a, 15b, to remove it. The sealing element 7 may also get stuck in the outlet 22 if the cap 1 is not removed axially from the delivery system 2.

In some embodiments the cap 1 further comprises a tactile portion 20 on the outer wall 3, the tactile portion 20 being detectable by a user's touch when gripping the cap 1, for example when removing the cap 1. The tactile portion 20 is configured to provide an enhanced gripping surface when compared with gripping the outer wall 3 without a tactile portion 20. The tactile portion 20 also facilitates detection by a user that the cap 1 is on the delivery system 1 without a visual confirmation, informing the user that the cap 1 needs to be removed before attempting to draw on the mouthpiece 6.

The tactile portion 20 may be provided by a dent, grooves, formations, ridges or an alternative material to the material of the outer wall 3. The tactile portion 20 may comprise a logo, image, word or a pattern.

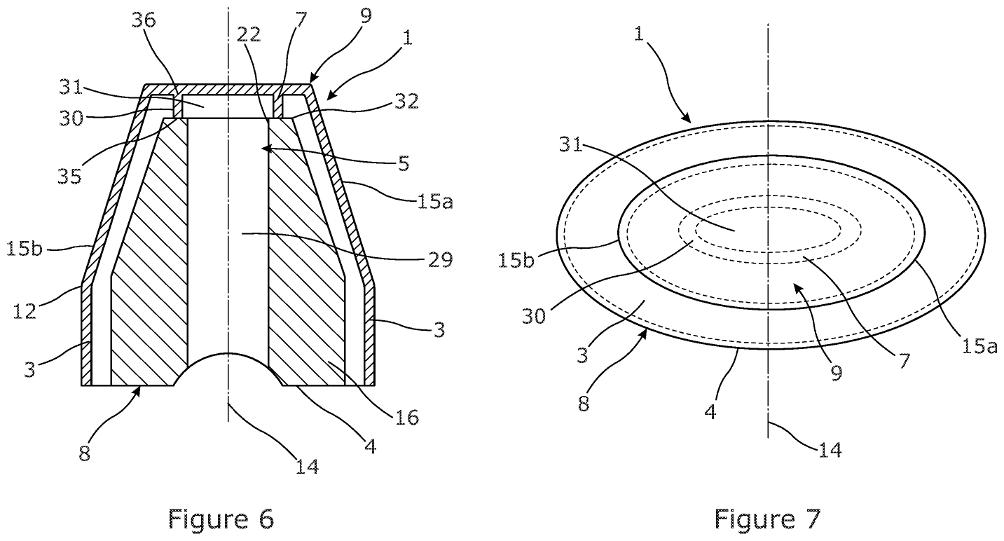

FIGS. 6 and 7 show a cap 1 of a further embodiment. FIG. 6 shows a cross-sectional front view of the mouthpiece 6 received in the cap 1 and FIG. 7 shows a top view of the cap 1. The cap 1 is substantially as described in any of the embodiments disclosed herein and like features retain the same reference numerals. A difference of this embodiment is that the sealing element 7 is configured to surround the outlet 22 of the mouthpiece 6 to seal it when the cap 1 is assembled or fitted with the delivery system 2.

The sealing element 7 comprises a cross-sectional area which is greater in size than the cross-sectional area of the outlet 22. The sealing element 7 comprises a sealing wall 30 which surrounds the outlet 22. The sealing wall 30 defines a sealing cavity 31 which is in fluid communication with the outlet 22 when the cap 1 is assembled on the first end 17 of the delivery system 2. The sealing cavity 31 is not in fluid communication with the rest of the internal cavity 5 when the cap 1 is assembled such that the sealing element 7 and the mouthpiece 6 are engaged.

The sealing wall 30 is configured to engage the mouthpiece 6, such that the outlet 22 is sealed from fluid communication from the rest of the internal cavity 5. The seal is provided by the engagement of the sealing wall 30 and the mouthpiece 6. As shown in FIG. 6, the sealing wall 30 is in abutment with the mouthpiece 6.

The sealing element 7 surrounding the outlet 22 facilitates greater design freedom for manufacturing the cap 1 as there are a larger range of sizes and shapes which will still engage the mouthpiece 6 and surround the outlet 22 to seal the outlet 22.

Advantageously if the sealing element 7 of this embodiment is deformed or damaged through use or accidentally damaging the sealing element 7 it is unlikely to cause the cap 1 to become stuck on the mouthpiece 6, or prevent the cap 1 from being assembled with the delivery system 2. This improves the longevity and durability of the cap 1 before it needs to be replaced or repaired.

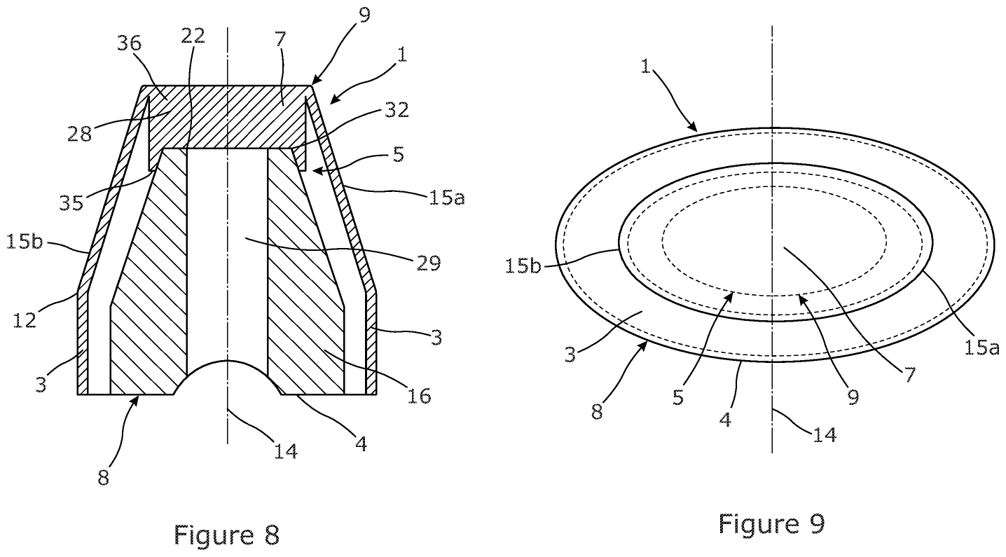

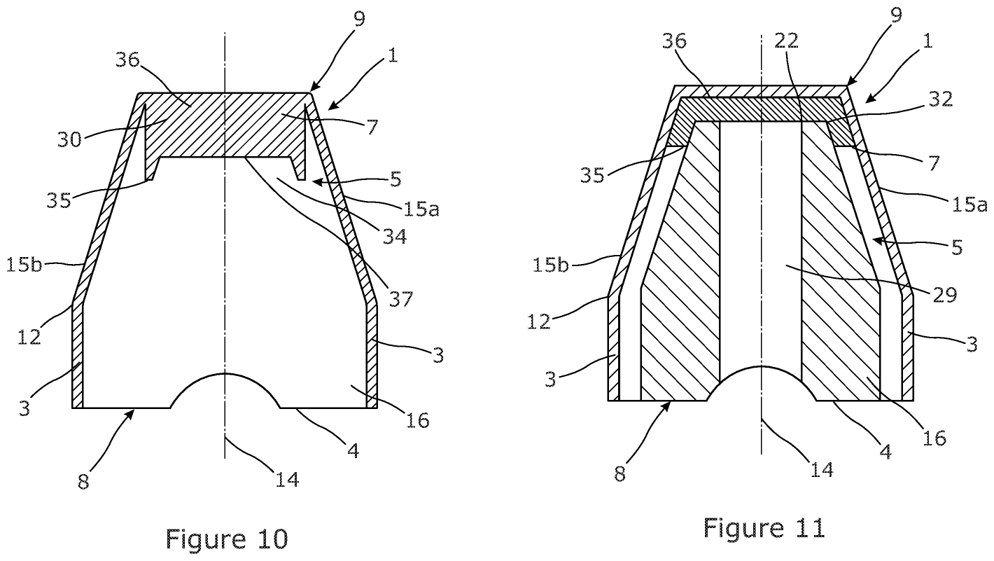

FIGS. 8 to 10 show a cap 1 of a further embodiment. FIG. 8 shows a cross-sectional front view of the mouthpiece 6 received in the cap 1, FIG. 9 shows a top view of the cap 1 and FIG. 10 shows a front view of the cap 1 without the mouthpiece 6. The cap 1 is substantially as described in any of the embodiments disclosed herein and like features retain the same reference numerals. A difference of this embodiment is that the sealing element 7 is configured to surround a tip 32, or extend across the outlet 22, of the mouthpiece 6.

The tip 32 is the portion of the mouthpiece closest to the first end 17 of the delivery system 2. The sealing element 7 of FIGS. 8 to 10 extends past the tip 32 towards the first end 8 of the cap 1 to substantially surround the mouthpiece 6.

As seen best in FIG. 10, the sealing element 7 further comprises a well 34 to receive the tip 32 of the mouthpiece 6 when the cap 1 is assembled with the first end 17 of the delivery system 2. The well 34 is formed as a pocket in the first end 35 of the sealing element 7. The well 34 comprises a base 37 which is closer to the second end 9 of the cap 1, than the first end 35 of the sealing element 7 is from the second end 9 of the cap 1.

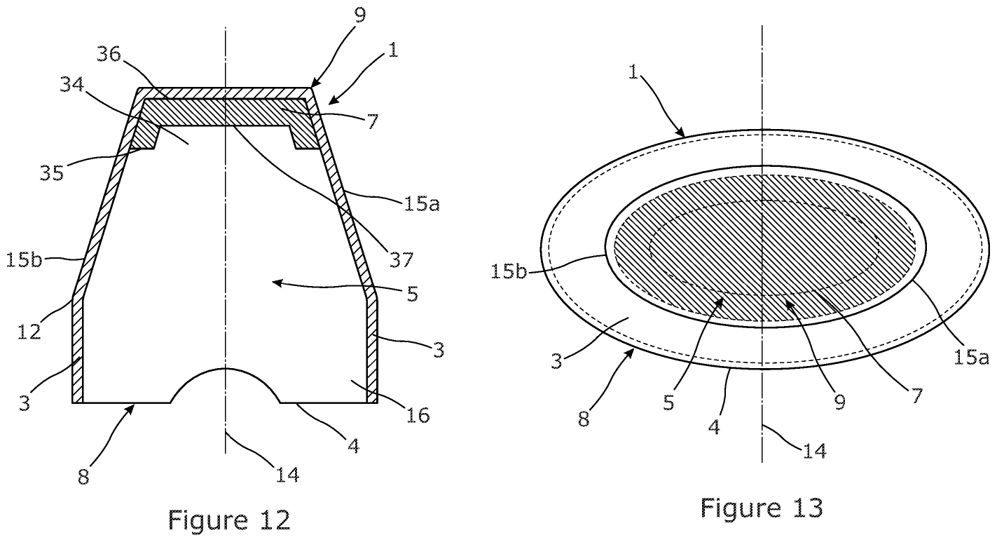

FIGS. 11 to 13 show a cap 1 of a further embodiment. Figure ii shows a cross-sectional front view of the mouthpiece 6 received in the cap 1, FIG. 12 shows a cross-sectional front view of the cap 1 without the mouthpiece 6, FIG. 13 shows a top view of the cap 1. The cap 1 is substantially as described in any of the embodiments disclosed herein and like features retain the same reference numerals. A difference of this embodiment is that the sealing element 7 extends entirely across the width of the internal cavity 5, to substantially fill the internal cavity 5 towards the second end 9 of the cap 1.

In some embodiments the sealing element 7 is made from a different material to the material of the outer wall 3. In this embodiment the outer wall 3 may be rigid and the sealing element 7 can be formed of a resilient material. It can be appreciated that any embodiment described herein may comprise a sealing element 7 formed of a different material to the outer wall 3.

The sealing element 7 being made of a resilient material may facilitate an improved seal between the sealing element and the mouthpiece 6. It may also reduce the pressure applied to the mouthpiece 6 from the sealing element 7 when the cap 1 is pushed onto the first end 17 of the delivery system 2.

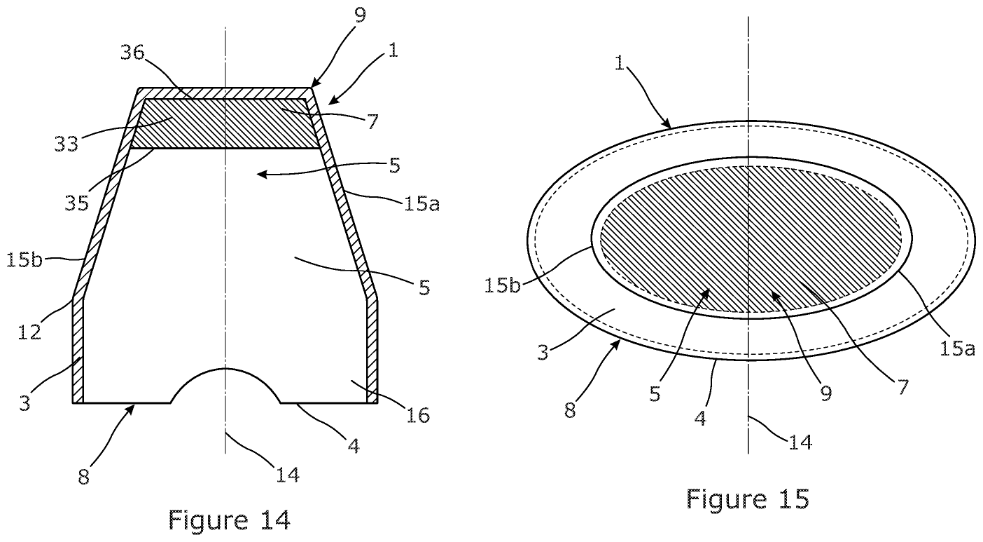

FIGS. 14 and 15 show a cap 1 of a further embodiment. FIG. 14 shows a cross-sectional front view of the cap 1 and FIG. 15 shows a top view of the cap 1. The front view of the sealing element 7 of this embodiment when assembled with the delivery system 2 is the same as Figure ii. The cap 1 is substantially as described in any of the embodiments disclosed herein and like features retain the same reference numerals. A difference of this embodiment is that the sealing element 7 is provided as a sealing layer 33 in the internal cavity 5 of the cap 1 at the second end 9.

The sealing layer 33 is made of a compressible material, such that the mouthpiece 6 can be pushed into the sealing layer 33, to surround the tip 32 of the mouthpiece 6 to form a seal.

Advantageously this sealing layer 33 can be easily replaced by a user as it does not need to be accurately located to form a seal with the mouthpiece 6. The sealing layer 33 also facilitates simple and efficient manufacturing, as the sealing layer 33 can accommodate a higher variation of dimensions due to its compressible properties.

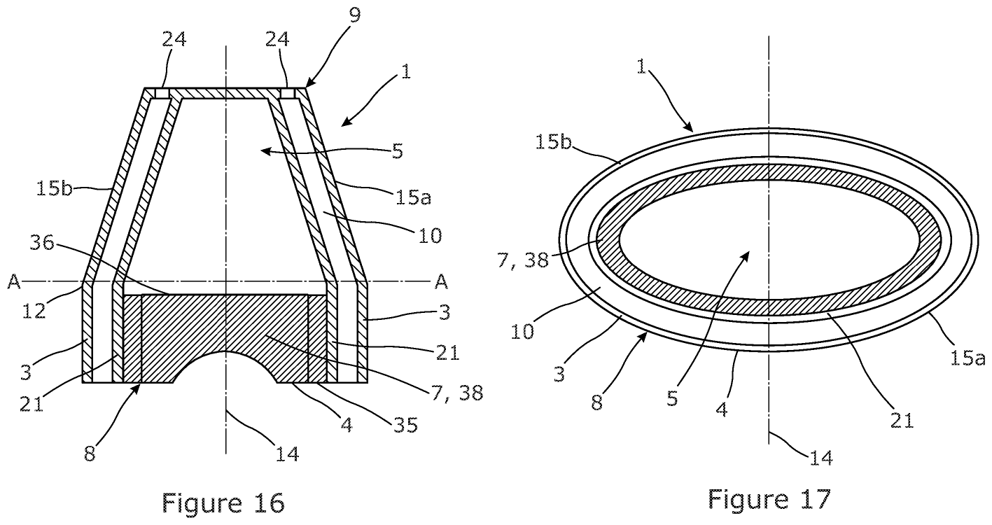

FIGS. 16 and 17 show a cap 1 of a further embodiment. FIG. 16 shows a cross-sectional front view of the cap 1 and FIG. 17 shows a cross-sectional top view of the cap 1 taken through line A-A of FIG. 16. The cap 1 is substantially as described in any of the embodiments disclosed herein and like features retain the same reference numerals. A difference of this embodiment is that the sealing element 7 is provided as a sealing ring 38. A further difference of this embodiment is that the cap 1 further comprises an inner wall 21, and at least one aperture 24, separate to the entrance opening 4.

The inner wall 21 is provided between the outer wall 3 and a central portion of the internal cavity 5. The inner wall 21 is configured to be disposed between the outer wall 3 and the mouthpiece 6 of the delivery system 2 when assembled on a first end 17 of the delivery system 2. An airflow passage 10 is defined between the inner wall 21 and the outer wall 3. The aperture(s) 24 are in fluid communication with the airflow passage 10 such that if a user attempts to draw on the mouthpiece 6 before removing the cap 1, air is drawn through an outer annular region of the entrance opening 4, into and through the airflow passage 10 and through the aperture(s) 24 into a user's mouth.

The cap 1 may comprise more than one inner wall, and the or each inner wall may extend entirely or partially around the inner circumference of the outer wall 3. In an alternative arrangement the cap 1 may include a plurality of inner walls 21 extending substantially inwardly from the outer wall 3, and may extend perpendicularly from the outer wall 3. Such inner wall(s) 21 may define open channels between themselves which serve as airflow passages 10 within the internal cavity 5 of the cap 1.

Sealing ring 38 extends annularly around an inner surface of the inner wall 21 to seal the outlet 22 when the cap is fitted to the delivery system 2. Advantageously, the sealing ring 38 seals a portion of the internal cavity 5 without contacting the tip 32 of the mouthpiece 6. The sealing ring 38 can also fluidly isolate the outlet 22 from the airflow passage 10.

It can be appreciated that the inner wall 21 and the sealing ring 38 are not mutually dependent features. That is, each may be provided independently of the other in alternative embodiments envisaged within the present disclosure. For example, in alternative embodiments the inner wall 21 can be combined with a sealing element 7 from any other embodiment described herein. In some embodiments the cap 1 does not comprise an inner wall 21 and the sealing ring 38 is disposed on an inner surface of the outer wall 3.

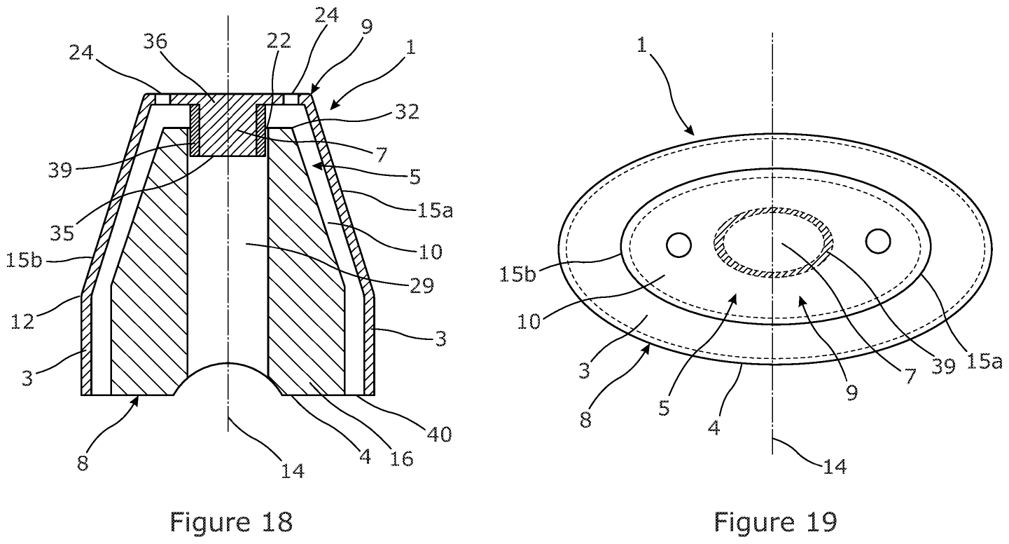

FIGS. 18 and 19 show a cap 1 of a further embodiment. FIG. 18 shows a cross-sectional front view of the cap 1 and FIG. 19 shows a top view of the cap 1. The cap 1 may be substantially as described in any of the embodiments disclosed herein and like features retain the same reference numerals. A difference of this embodiment is that the outer wall 3 of the cap 1 includes at least one aperture 24, separate to the entrance opening 4, configured to allow airflow into and out of the internal cavity 5. A further difference of this embodiment is that the sealing element 7 is formed from the same material as the outer wall 3, however it comprises at least one additional sealing portion 39 of a second material.

The second material is a different material to the rest of the sealing element 7, which can be referred to as a first material. In some embodiments the second material is a resilient material to facilitate improvement of the seal between the sealing element 7 and the mouthpiece 6.

In the embodiment shown in FIGS. 18 and 19, the cap 1 comprises two apertures 24 disposed in the second end 9 of the cap 1. However, it can be appreciated that any number, shape and size of aperture 24 may be provided in any part of the outer wall 3.

Advantageously providing the apertures 24 at the second end 9 means that if a user attempts to draw on the mouthpiece 6 before removing the cap 1 they will draw air through the air passage 10. This can prevent the cap 1 from accidentally being separated from the delivery system 2 and sucked into a user's mouth. When the cap 1 is assembled covering the mouthpiece 6 of the delivery system 2, then the airflow passage 10 (seen in FIG. 18) is considered to extend from the entrance opening 4, around the mouthpiece 6 of the delivery system 2, and through the apertures 24.

In some embodiments an annular or part-annular space or gap 40 is defined at the first end 8 of the cap 1 between the cap 1 and the delivery system 2. The annular or part annular space 40 is in fluid communication with the airflow passage 10 and the at least one aperture 24. Air is drawn into the annular or part annular space 40, through the airflow passage 10 and through the apertures 24 into a user's mouth. In some embodiments described herein there may be provided such a feature of an annular or part-annular space or gap 40 defined at the first end 8 of the cap 1 between the cap 1 and the delivery system 2.

It can be appreciated that the additional sealing portion 39 and the apertures 24 are not mutually dependent. That is, each may be provided independently of the other in alternative embodiments envisaged within the present disclosure. For example, in alternative embodiments both the additional sealing portion 39 and the apertures 24 can separately or together be combined with a sealing element 7 from any other embodiment described herein.

In embodiments in which the cap 1 comprises apertures 24, the airflow passage 10 is fluidly isolated from the mouthpiece 6 and/or the outlet 22 by the sealing element 7 and/or the configuration of the airflow passage 10. This may facilitate to extend the life of the substance within the delivery system 2, as if a user attempts to draw on the mouthpiece 6 before removing the cap 1, air is drawn through the air passage 10 and not from the outlet 22 of the mouthpiece 6. Furthermore, the mouthpiece 6 of the delivery system 2 is protected from debris or contaminants improving the overall hygiene of the mouthpiece 6.

In any of the above described embodiments the cap 1 may further comprise a secondary sealing element (not shown). The secondary sealing element is configured to engage with a portion of the delivery system 2 to substantially seal the cap 1 against the portion of the delivery system 2 when assembled together.

In any of the above described embodiments the cap 1 may further comprise inlets (not shown) provided through the outer wall 3. The inlets may be disposed further towards the entrance opening 4 than the apertures 24. The air inlets are in fluid communication with the airflow passage 10 such that when a user attempts to draw on the mouthpiece 6 before removing the cap 1, air is drawn through the air inlets, into the airflow passage 10, and through the apertures 24 into a user's mouth.

Various embodiments described above facilitate an improved cap 1 in which contaminants or debris cannot enter the outlet 22, in which the mouthpiece may be more hygienic as it protected by the sealing element 7, and in which the outlet 22 is sealed from the external environment, reducing the effects of hot or wet weather on the substance for delivery through the outlet 22.

It is further envisaged that any combination of the cap features, and particularly sealing element configurations, airflow passage configurations and apertures, described in the various embodiments above may be provided in any combination in alternative embodiments within the present disclosure.

In the above described embodiments the outer wall 3 comprises a substantially consistent thickness throughout. However in alternative embodiments intended within the present disclosure the outer wall 3 can comprise thicker or thinner portions for reinforcement, ergonomic considerations or weight considerations among other factors.

In the above described embodiments the internal cavity 5 comprises a greater cross sectional area towards the entrance opening 4 than towards the second end 9. This is to receive a base of the mouthpiece 6, or to receive a body ii of the delivery system 2. However, in alternative embodiments intended within the scope of the present disclosure the internal cavity 5 may not comprise a greater cross-sectional area towards the entrance opening 4. In these embodiments the cap 1 may comprise a separate stop in the form of protrusions or formations in the internal cavity 5 to prevent the delivery system 2 from being pushed too far into the cap 1. Alternatively there may be no means of preventing the delivery system 2 from being pushed too far into the cap 1. In some embodiments the body ii of the delivery system 2 may comprise a stop to prevent the delivery system 2 from being pushed too far into the cap 1.

In the above described embodiments the outer wall 3 is made of a rigid material such as a rigid plastic. Many alternative materials can be used as the material of the outer wall 3, for example metal, wood, bamboo or ceramic. In some embodiments the material of the outer wall 3 is biodegradable. Alternatively the outer wall 3 may be made from a non-rigid material.

In some embodiments the material of the outer wall 3 is transparent or translucent such that the portion of the delivery system 2 can be seen through the cap 1 even when the cap is assembled with the delivery system 2. However in alternative embodiments intended within the scope of the present disclosure, the material of the outer wall 3 may be opaque, or may comprise visible inclusions or particles in a transparent or translucent base which hinder a user's view through the cap 1.

In the above described embodiments the receiving portion 16 is configured to provide a close fit against the aforementioned portion of the delivery system 2 such that when the delivery system 2 is received in the cap 1, the cap 1 remains attached to the delivery system until such time that the user removes the cap 1. However in alternative embodiments intended within the scope of the present disclosure an alternative part of the cap 1 may be configured to engage with the delivery system 2. For example the shoulder 12 or an inner wall 21 of the cap 1 may be configured to engage with the delivery system 2 such that when the delivery system 2 is received in the cap 1, the cap 1 remains attached to the delivery system until such time that the user removes the cap 1. This engagement could be through a close fit configuration with the delivery system 2 or engagement members 19 described above.

In the above described embodiments the at least one engagement member 19 is formed of the same material as the outer wall 3. However in alternative embodiments intended within the scope of the present disclosure the engagement member(s) 19 may comprise a different material to the outer wall 3, for example the engagement member(s) may comprise a resilient material to provide improved engagement with the delivery system 2.

In the above described embodiments the at least one engagement member 19 is integrally formed with the outer wall 3. However in alternative embodiments intended within the scope of the present disclosure the engagement member(s) 19 may be a separate component which has been bonded or attached to the cap 1 by any known means.

In the above described embodiments the engagement members 19 are arranged symmetrically about the central plane 14. However in alternative embodiments intended within the scope of the present disclosure the engagement members 19 can be arranged in a number of different formations. For example the engagement members 19 may be equally spaced, unequally spaced, there may be an odd number and therefore are not symmetrical about the central plane 14, each engagement member 19 or group of engagement members 19 may be differently shaped or sized.

In the above described embodiments the cap 1 comprises four engagement members 19, two arranged on the first side 15a and two arranged on the second side 15b. However in alternative embodiments intended within the scope of the present disclosure there could be less than four engagement members 19, for example there could be a single engagement member 19 in the form of a continuous ring around the internal cavity 5. In some embodiments there could be more than 4 engagement members 19, for example a series of engagement members 19 in a discontinuous ring around the internal cavity 4 or a plurality of engagement members 19 arranged randomly around the internal cavity 5. It can be appreciated that alternative arrangements of the engagement members 19 than those described herein can be envisaged.

In the above described embodiments the cap 1 comprises at least one engagement member 19. However in alternative embodiments intended within the scope of the present disclosure the cap 1 may not comprise an engagement member 19. In such an embodiment the receiving portion 16 of the cap 1 may directly engage the delivery system 2 to attach the cap 1 to the delivery system 2. Alternatively or additionally, the at least one engagement member 19 may be provided on the delivery system 2.

In the above described embodiments the cap 1 comprises a tactile portion 20. However in alternative embodiments intended within the present disclosure the cap 1 does not comprise a tactile portion 20 and the cap 1 can be sufficiently gripped and removed by a user without the provision of the tactile portion 20.

In the above described embodiments the sealing element 7 comprises a sealing wall 30 and a sealing cavity 31. However, in alternative embodiments intended within the present disclosure the sealing element 7 that surrounds the outlet 22 may be solid such that there is no sealing cavity 31.

In the above described embodiments the sealing element 7 extends over less than 25% of the distance from the second end 9 to the first end 8 of the cap 1. However, in alternative embodiments intended within the present disclosure the sealing element 7 extends over less than 50%, less than 30% or less than 10% of the distance from the second end 9 to the first end 8 of the cap 1.

In the above described embodiments the cross-sectional area of the sealing element 7 is a similar shape as the cross-sectional area of the outlet 22. However, in alternative embodiments intended within the present disclosure the sealing element 7 may comprise a cross-sectional shape that is different from the outlet 22. For example, in the embodiment shown in FIGS. 6 and 7, the sealing element 7 can be polygonal in cross-section even if the outlet 22 is elliptical in cross-section.

In the above described embodiments the aperture(s) 24 are circular in shape, however they may be shaped like an annulus, comprise a plurality of randomly arranged apertures 24 of different shapes and sizes, comprise an arrangement of apertures 24 forming a logo, word, symbol or image or comprise a plurality of small apertures 24 forming a mesh or grid.

In the above described embodiments the internal cavity 5 is entirely closed by the outer wall 3, except for the entrance opening 4 and in some embodiments apertures 24. However, in alternative embodiments intended within the scope of the present disclosure the outer wall 3 may comprise further apertures or openings. These further apertures or openings may be for example for ventilation, weight reduction, to improve the airflow through the cap 1 or to receive a further part of the delivery system 2 or another component.

As used herein, the term “delivery system” is intended to encompass systems that deliver at least one substance to a user, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material);
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials; and
aerosol-free delivery systems that deliver the at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energized so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the substance to be delivered may be an aerosol-generating material or a material that is not intended to be aerosolised. As appropriate, either material may comprise one or more active constituents, one or more flavors, one or more aerosol-former materials, and/or one or more other functional materials.

The delivery system described herein can be implemented as a combustible aerosol provision system, a non-combustible aerosol provision system or an aerosol-free delivery system.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A cap for use with a delivery system, the cap comprising an outer wall defining an internal cavity configured to receive a mouthpiece of the delivery system, and a sealing element within the cavity configured to engage with the delivery system mouthpiece and to seal an outlet of the delivery system mouthpiece, when the cap is fitted to a delivery system.

2. A cap according to claim 1, wherein the sealing element comprises a formation extending into the internal cavity configured to be received within an outlet of a delivery system mouthpiece so as to seal the outlet when the cap is fitted to a delivery system.

3. A cap according to claim 1, wherein the sealing element comprises a formation extending into the internal cavity which surrounds, or extends across an outlet of a delivery system mouthpiece so as to seal the outlet when the cap is fitted to a delivery system.

4. A cap according to claim 1, wherein the sealing element is integrally formed with the outer wall.

5. A cap according to claim 1, wherein the sealing element is a separate component to the outer wall which is secured thereto.

6. A cap according to claim 1, wherein the sealing element is at least partially formed from the same material as the outer wall.

7. A cap according to claim 1, wherein the sealing element comprises a portion of resilient material configured to be compressed against at least a part of a delivery system mouthpiece when the cap is fitted to a delivery system.

8. A cap according to claim 1, wherein the sealing element is entirely formed from the same material as the outer wall.

9. A cap according to claim 1, wherein the sealing element is a rigid formation.

10. A cap according to claim 1, wherein the sealing element is entirely comprised of a resilient or compressible material.

11. A cap according to claim 1, wherein the sealing element comprises a first end which extends towards the entrance opening of the cap and a second end which is coupled to the outer wall.

12. A cap according to claim 1, wherein the cap comprises a first end proximate the entrance opening and a second end opposite to the first end.

13. A cap according to claim 12 wherein the sealing element extends over less than 25% of a distance from the second end to the first end of the cap.

14. A cap according to claim 12, wherein the outer wall comprises an end wall at the second end and a sidewall extending from the end wall to the entrance opening, wherein the end wall comprises the sealing element.

15. A cap according to claim 1, wherein the sealing element comprises a sealing wall surrounding a sealing cavity, the sealing wall is configured to engage a mouthpiece of the delivery system so as to seal an outlet of the mouthpiece when the cap is fitted to a delivery system, wherein the sealing cavity remains in fluid communication with the outlet.

16. A cap according to claim 1, when dependent on claim 11, wherein the sealing element comprises a well to receive a tip of a mouthpiece of a delivery system when the cap is fitted to a delivery system, wherein the well is formed as a pocket in the first end of the sealing element.

17. A cap according to claim 1, wherein the sealing element comprises a sealing layer which extends substantially flat across the internal cavity before the cap is fitted with a delivery system, the sealing layer comprises a compressible material to which a mouthpiece of a delivery system can be pushed into so as to seal an outlet of the mouthpiece when the cap is fitted with a delivery system.

18. A cap according to claim 1, wherein the sealing element comprises a sealing ring, extending annularly around the internal cavity so as to form a seal with a mouthpiece of a delivery system when the cap is fitted with a delivery system.

19. A cap according to claim 1, wherein the cap comprises a central longitudinal plane extending through the first end, the internal cavity and the second end and the sealing element is arranged symmetrically about the central longitudinal plane.

20. A cap according to claim 1, wherein the cap comprises at least one aperture through the outer wall.

21. A cap according to claim 20 wherein an airflow passage is defined through the internal cavity between the aperture(s) and the entrance opening.

22. A cap according to claim 20, further comprising at least one inner wall configured so as to be disposed between the outer wall and a mouthpiece of the delivery system when the cap is fitted to a delivery system, wherein an airflow passage is defined at least by the outer wall and the or at least one of the inner wall(s).

23. A cap according to claim 1, further comprising a receiving portion configured to engage with a delivery system to secure the cap to the delivery system.

24. A cap according to claim 23, wherein the receiving portion comprises at least one formation extending into the internal cavity, configured to provide a friction fit attachment with a delivery system.

25. A delivery system comprising a mouthpiece and a body, and cap according to claim 1 removably attached to the delivery system to cover the mouthpiece, wherein the mouthpiece comprises an outlet for delivery of a substance to user.

26. A delivery system according to claim 25, wherein the sealing element seals an outlet of the delivery system mouthpiece.

27. A delivery system according to claim 25, wherein the sealing element is received within the outlet.

28. A delivery system according to claim 25, wherein the sealing element surrounds, or extends across the outlet.

29. A delivery system according to claim 25, wherein the airflow passage is defined between the outer wall and the mouthpiece.

30. A delivery system according to claim 25, wherein at least one inner wall is disposed between the outer wall and a mouthpiece of the delivery system, wherein the cap comprises at least one aperture through the outer wall and an airflow passage is defined through the internal cavity between the at least one aperture and the entrance opening and the airflow passage is defined at least by the outer wall and the or at least one of the inner wall(s).

31. A delivery system according to claim 25, wherein the cap comprises at least one aperture through the outer wall and an airflow passage is defined through the internal cavity between the at least one aperture and the entrance opening and wherein the airflow passage is fluidly isolated from the outlet of the mouthpiece.
